(19) United States
(12) Patent Application Publication
(10) Pub. No.: US 2025/0266478 A1
(43) Pub. Date: Aug. 21, 2025

(54) REGENERATIVE FUEL CELL SYSTEM

(71) Applicant: HONDA MOTOR CO., LTD., TOKYO (JP)

(72) Inventors: Keizo IWAMA, WAKO-SHI (JP); Eiji HARYU, WAKO-SHI (JP)

(21) Appl. No.: 19/027,490

(22) Filed: Jan. 17, 2025

(30) Foreign Application Priority Data
Feb. 15, 2024 (JP) 2024-021142

(51) Int. Cl. H01M 8/04746; H01M 8/0444; H01M 8/0656

(52) U.S. Cl. CPC H01M 8/04776; H01M 8/0444; H01M 8/0656

(57) ABSTRACT

A regenerative fuel cell system includes a water electrolysis device for performing electrolysis of alkaline water, a fuel cell for performing power generation by using a generated gas that is a gas generated by the electrolysis, a storage container for storing generated water that is water generated by the power generation, and a gas flow path for guiding the generated gas to the fuel cell through the generated water stored in the storage container.

### CROSS-REFERENCE TO RELATED APPLICATIONS

This application is based upon and claims the benefit of priority from Japanese Patent Application No. 2024-021142 filed on Feb. 15, 2024, the contents of which are incorporated herein by reference.

### BACKGROUND OF THE INVENTION

### Field of the Invention

The present disclosure relates to a regenerative fuel cell system.

### Description of the Related Art

In recent years, research and development have been conducted on fuel cells that contribute to energy efficiency in order to ensure that more people have access to affordable, reliable, sustainable and modern energy.

JP 2023-117525 A discloses a regenerative fuel cell system including a water electrolysis device and a fuel cell. In this regenerative fuel cell system, the water electrolysis device generates gas by electrolyzing water. The fuel cell generates electric power using gas generated by electrolysis of the water electrolysis device.

### SUMMARY OF THE INVENTION

Alkaline water may be supplied to the water electrolysis device. In this case, the gas generated by the electrolysis of the water electrolysis device contains the alkaline water. When alkaline water is supplied to the fuel cell, a problem may occur in that the durability of the fuel cell is reduced.

An object of the present invention is to solve the aforementioned problem.

An aspect of the present disclosure is characterized by a regenerative fuel cell system including: a water electrolysis device configured to perform electrolysis of alkaline water; a fuel cell configured to perform power generation by using a generated gas that is a gas generated by the electrolysis; a storage container configured to store generated water that is water generated by the power generation; and a gas flow path configured to guide the generated gas to the fuel cell through the generated water stored in the storage container.

Thus, even if alkaline water is contained in the generated gas, the alkaline water can be neutralized by the generated water stored in the storage container. As a result, the durability of the fuel cell can be prevented from deteriorating.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a regenerative fuel cell system according to a first embodiment;

FIG. 2 is a block diagram of a control device;

FIG. 3 is a flowchart showing a procedure of an operation stop control of a water electrolysis device;

FIG. 4 is a diagram showing a storage container;

FIG. 5 is a schematic view showing a regenerative fuel cell system according to a second embodiment; and

FIG. 6 is a flowchart showing a procedure of a concentration control.

### DETAILED DESCRIPTION OF THE INVENTION

### First Embodiment

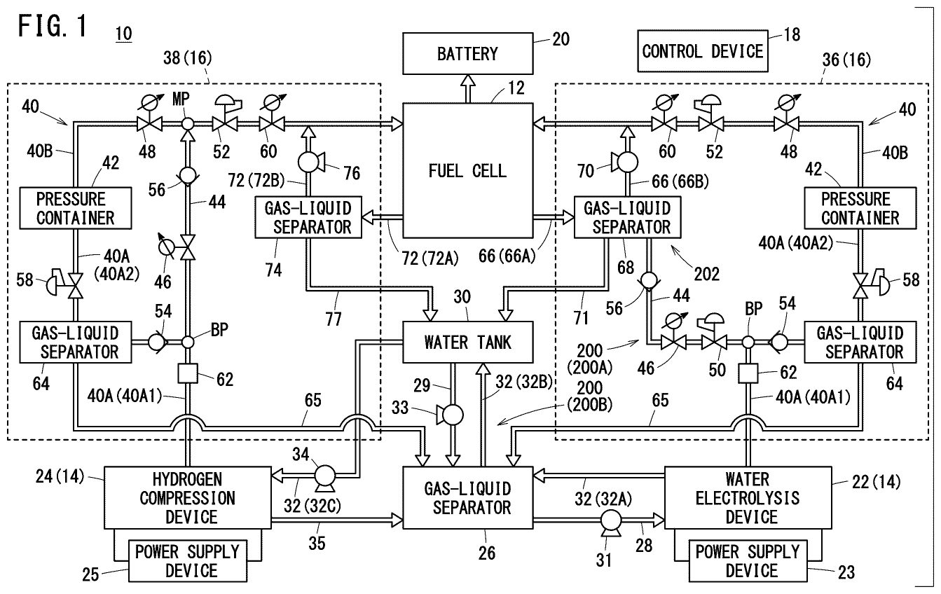

FIG. 1 is a schematic view showing a regenerative fuel cell system 10 according to a first embodiment. The regenerative fuel cell system 10 includes a fuel cell 12, a gas generation device 14, a supply mechanism 16, and a control device 18.

The fuel cell 12 generates power through an electrochemical reaction between oxygen gas and hydrogen gas. The fuel cell 12 includes a plurality of electrochemical cells. Each electrochemical cell includes an electrolyte membrane and a pair of electrodes provided on both sides of the electrolyte membrane in the thickness direction. The electrolyte membrane used in the fuel cell 12 is a proton exchange membrane. One of the pair of electrodes is an anode, and the other of the pair of electrodes is a cathode. The fuel cell 12 supplies hydrogen gas to the anode of each electrochemical cell. The fuel cell 12 supplies oxygen gas to the cathode of each electrochemical cell. The fuel cell 12 collects power generated in each electrochemical cell by an electrochemical reaction between oxygen gas and hydrogen gas, and stores the power in a battery 20.

The fuel cell 12 collects excess oxygen gas that has not undergone the electrochemical reaction, and discharges oxygen-containing exhaust gas containing that oxygen gas. Most of the oxygen-containing exhaust gas is circulated to the fuel cell 12 again and reused. The fuel cell 12 collects excess hydrogen gas that has not undergone the electrochemical reaction, and discharges hydrogen-containing exhaust gas containing that hydrogen gas. Most of the hydrogen-containing exhaust gas is circulated to the fuel cell 12 again and reused.

The gas generation device 14 is a device that generates one of oxygen gas or hydrogen gas. A water electrolysis device 22 and a hydrogen compression device 24 are provided as the gas generation device 14.

The water electrolysis device 22 is a gas generation device 14 that generates oxygen gas and hydrogen gas by electrolyzing water. Water is supplied from a gas-liquid separator 26 via a water supply path 28. The water supplied to the water electrolysis device 22 is alkaline water. For example, the water supplied to the water electrolysis device 22 is water containing potassium hydroxide. The water supply path 28 connects the gas-liquid separator 26 and the water electrolysis device 22. A water supply pump 31 is provided in a portion of the water supply path 28 between the gas-liquid separator 26 and the water electrolysis device 22. The water supply pump 31 supplies water stored in the gas-liquid separator 26 to the water electrolysis device 22.

The gas-liquid separator 26 is supplied with supplementary water from a water tank 30 via a supplementary water path 29. The supplementary water is water to be added to the water (alkaline water) to be supplied to the water electrolysis device 22. A water supply pump 33 is provided in the supplementary water path 29. The supplementary water is supplied to the gas-liquid separator 26 by the water supply pump 33.

The water electrolysis device 22 includes a plurality of electrochemical cells. Each electrochemical cell includes an electrolyte membrane and a pair of electrodes provided on both sides of the electrolyte membrane in the thickness direction. The electrolyte membrane used in the water electrolysis device 22 is an anion exchange membrane. One of the pair of electrodes is an anode, and the other of the pair of electrodes is a cathode. A power supply device 23 is connected to the anode and the cathode. The power supply device 23 is configured to be able to change the voltage value of the voltage applied to the anode and the cathode. The power supply device 23 may obtain power for the voltage to be applied between the anode and the cathode, from the battery 20.

The water electrolysis device 22 supplies water flowing in from the water supply path 28 to the cathode of each electrochemical cell. Each electrochemical cell electrolyzes water based on the voltage applied by the power supply device 23. As a result, oxygen gas is generated at the anode, and hydrogen gas is generated at the cathode. The oxygen gas generated in the water electrolysis device 22 is compressed to a high pressure. For example, the oxygen gas is compressed in a range of 1 to 100 MPa.

The water electrolysis device 22 collects oxygen gas generated in each electrochemical cell and outputs exhaust gas containing that oxygen gas to the supply mechanism 16. The exhaust gas contains water vapor vaporized by heat of the water electrolysis device 22 or the like. On the other hand, the water electrolysis device 22 collects hydrogen gas generated in each electrochemical cell and excess water (unreacted water) that has not been electrolyzed, and discharges exhaust fluid containing the hydrogen gas and the unreacted water to a hydrogen supply path 32. The exhaust fluid also includes water vapor vaporized by heat of the water electrolysis device 22 or the like.

The hydrogen supply path 32 includes a first partial flow path 32A, a second partial flow path 32B, and a third partial flow path 32C. The first partial flow path 32A connects the water electrolysis device 22 and the gas-liquid separator 26. The second partial flow path 32B connects the gas-liquid separator 26 and the water tank 30. The third partial flow path 32C connects the water tank 30 and the hydrogen compression device 24. A gas supply pump 34 is provided in the third partial flow path 32C.

The exhaust fluid output from the water electrolysis device 22 flows into the gas-liquid separator 26 via the first partial flow path 32A. The gas-liquid separator 26 separates the exhaust fluid into a liquid component (liquid water) and a gas component (hydrogen gas). The liquid water is supplied to the water electrolysis device 22 by the water supply pump 31. The hydrogen gas is supplied to the hydrogen compression device 24 by the gas supply pump 34.

The hydrogen compression device 24 is the gas generation device 14 that generates high-pressure hydrogen gas. The hydrogen compression device 24 pressurizes hydrogen gas flowing in from the hydrogen supply path 32. The hydrogen gas flowing in from the hydrogen supply path 32 is hydrogen gas generated by the water electrolysis device 22.

The hydrogen compression device 24 includes a plurality of electrochemical cells. Each electrochemical cell includes an electrolyte membrane and a pair of electrodes provided on both sides of the electrolyte membrane in the thickness direction. The electrolyte membrane used in the hydrogen compression device 24 is a proton exchange membrane. One of the pair of electrodes is an anode, and the other of the pair of electrodes is a cathode. A power supply device 25 is connected to the anode and the cathode. The power supply device 25 is configured to be able to change the voltage value of the voltage applied between the anode and the cathode. The power supply device 25 may obtain power for the voltage to be applied between the anode and the cathode, from the battery 20.

The hydrogen compression device 24 supplies the hydrogen gas flowing in from the hydrogen supply path 32, to the anode. The hydrogen compression device 24 ionizes the hydrogen gas based on the voltage applied by the power supply device 25. Protons obtained by ionization of the hydrogen gas return to hydrogen gas when they reach the cathode via the electrolyte membrane (proton exchange membrane). The hydrogen compression device 24 may compress hydrogen gas by moving protons from the anode to a closed space including the cathode. For example, the hydrogen containing gas is compressed in a range of 1 to 100 MPa. In this way, the hydrogen compression device 24 is an electrochemical hydrogen compressor (EHC) configured to compress hydrogen gas electrochemically.

The hydrogen compression device 24 outputs exhaust gas containing the compressed hydrogen gas to the supply mechanism 16. The exhaust gas contains water vapor vaporized by heat of the hydrogen compression device 24 or the like. On the other hand, the hydrogen compression device 24 discharges excess hydrogen gas that has not been ionized, to a hydrogen discharge path 35. The hydrogen discharge path 35 connects the hydrogen compression device 24 and the gas-liquid separator 26.

The supply mechanism 16 includes an oxygen supply mechanism 36 and a hydrogen supply mechanism 38 as the supply mechanism 16 for supplying gas to the fuel cell 12. The oxygen supply mechanism 36 is the supply mechanism 16 for supplying the oxygen gas generated by the water electrolysis device 22 to the fuel cell 12. The hydrogen supply mechanism 38 is the supply mechanism 16 for supplying the hydrogen gas generated by the hydrogen compression device 24 to the fuel cell 12.

The oxygen supply mechanism 36 and the hydrogen supply mechanism 38 have basically the same configuration. Accordingly, unless otherwise specified, the oxygen supply mechanism 36 and the hydrogen supply mechanism 38 will both be described as the supply mechanism 16.

In the following description, the “supply mechanism 16” refers to either one of the oxygen supply mechanism 36 or the hydrogen supply mechanism 38. Similarly, “gas” refers to either one of oxygen gas or hydrogen gas. Similarly, the term “gas generation device 14” refers to either the water electrolysis device 22 or the hydrogen compression device 24.

It should be noted that, when the “supply mechanism 16” is referring to the oxygen supply mechanism 36, the “gas” refers to oxygen gas, not hydrogen gas. Furthermore, it should be noted that, when the “supply mechanism 16” is referring to the oxygen supply mechanism 36, the “gas generation device 14” refers to the water electrolysis device 22, not the hydrogen compression device 24. Similarly, it should be noted that, when the “supply mechanism 16” is referring to the hydrogen supply mechanism 38, the “gas” refers to hydrogen gas, not oxygen gas. It should be noted that when the “supply mechanism 16” is referring to the hydrogen supply mechanism 38, the “gas generation device 14” refers to the hydrogen compression device 24, not the water electrolysis device 22.

The supply mechanism 16 includes a gas supply path 40, a pressure container 42, a bypass path 44, a first on-off valve 46, a second on-off valve 48, a first pressure regulating valve 50, a second pressure regulating valve 52, a first check valve 54, a second check valve 56, a pressure control valve 58, a flow regulating valve 60, a pressure sensor 62, and a gas-liquid separator 64.

The gas supply path 40 is a path for supplying gas from the gas generation device 14 to the fuel cell 12. The gas supply path 40 includes a first supply path 40A and a second supply path 40B. The first supply path 40A is a flow path that guides gas from the gas generation device 14 to the pressure container 42. The first supply path 40A includes a flow path portion 40A1 connecting the gas generation device 14 and the gas-liquid separator 64, and a flow path portion 40A2 connecting the gas-liquid separator 64 and the pressure container 42. The second supply path 40B is a flow path that guides gas from the pressure container 42 to the fuel cell 12.

The pressure container 42 is provided on the gas supply path 40. The pressure container 42 stores the gas generated by the gas generation device 14. The gas stored in the pressure container 42 is compressed.

The bypass path 44 is a path for supplying the gas generated by the gas generation device 14 to the fuel cell 12 without passing through the pressure container 42. The bypass path 44 of the oxygen supply mechanism 36 and the bypass path 44 of the hydrogen supply mechanism 38 are different from each other. The bypass path 44 of the oxygen supply mechanism 36 connects the flow path portion 40A1 of the first supply path 40A and a gas-liquid separator 68. The bypass path 44 of the hydrogen supply mechanism 38 connects the flow path portion 40A1 of the first supply path 40A and the second supply path 40B.

The first on-off valve 46 is provided in the bypass path 44. The first on-off valve 46 is configured to be openable and closable. The first on-off valve 46 opens and closes in accordance with the control of the control device 18. The first on-off valve 46 may be a shutoff valve. When an abnormality is detected, the shutoff valve shuts off the bypass path 44 without depending on the control of the control device 18.

The second on-off valve 48 is provided in the second supply path 40B. The second on-off valve 48 is configured to be openable and closable. The second on-off valve 48 opens and closes in accordance with the control of the control device 18. The second on-off valve 48 may be a shutoff valve.

The first pressure regulating valve 50 is provided in the bypass path 44 of the oxygen supply mechanism 36. The first pressure regulating valve 50 is not provided in the bypass path 44 of the hydrogen supply mechanism 38. The first pressure regulating valve 50 is positioned between the branching portion BP and the first on-off valve 46 in the bypass path 44 of the oxygen supply mechanism 36. The branch portion BP is a portion where the bypass path 44 branches from the first supply path 40A.

The second pressure regulating valve 52 is provided in the second supply path 40B at a position between the second on-off valve 48 and the fuel cell 12. The second pressure regulating valve 52 reduces the pressure of gas.

The first check valve 54 is provided in a portion of the first supply path 40A between the branch portion BP and the gas-liquid separator 64. The second check valve 56 is provided in a portion of the bypass path 44 positioned downstream of the first on-off valve 46.

The pressure control valve 58 is provided in the flow path portion 40A2 of the first supply path 40A. The pressure control valve 58 narrows the flow path portion 40A2. Thus, when the gas generation device 14 is the water electrolysis device 22, the pressure of the oxygen gas generated at the anode of each electrochemical cell increases to a pressure higher than the pressure of the hydrogen gas generated at the cathode of each electrochemical cell. The pressure control valve 58 may be a solenoid valve whose opening degree is adjustable. Alternatively, the pressure control valve 58 may be a back pressure valve.

That is, in the water electrolysis device 22, the pressure on the anode side of the electrolyte membrane is higher than the pressure on the cathode side of the electrolyte membrane. Therefore, it is possible to suppress crossover in which hydrogen gas generated at the cathode permeates through the electrolyte membrane toward the anode. As a result, it is possible to suppress a decrease in the amount of hydrogen gas supplied from the water electrolysis device 22 to the hydrogen compression device 24.

The flow regulating valve 60 is provided in the second supply path 40B. The flow regulating valve 60 is configured to be able to adjust the flow rate of the gas flowing through the fuel cell 12. The flow regulating valve 60 adjusts the flow rate in accordance with the control of the control device 18.

The pressure sensor 62 detects the pressure of the gas supplied to the gas supply path 40. The pressure sensor 62 outputs a signal indicating the detected pressure to the control device 18. The pressure sensor 62 is preferably provided in the gas supply path 40 near the gas generation device 14. For example, the pressure sensor 62 is provided in a portion of the first supply path 40A between the gas generation device 14 and the branch portion BP.

The gas-liquid separator 64 is provided on the gas supply path 40 between the pressure control valve 58 and the first check valve 54. As described above, the exhaust gas discharged from the gas generation device 14 to the gas supply path 40 contains water vapor in addition to the gas. The gas-liquid separator 64 separates the exhaust gas into a liquid component (liquid water) and a gas component (gas). The gas separated by the gas-liquid separator 64 is supplied to the pressure container 42. Therefore, it is possible to suppress the pressure container 42 from becoming humid. As a result, the durability of the pressure container 42 can be improved without making the pressure container 42 excessively rust-resistant.

On the other hand, the liquid water separated by the gas-liquid separator 64 is supplied to the gas-liquid separator 26 via a liquid water supply path 65. The liquid water supply path 65 connects the gas-liquid separator 64 and the gas-liquid separator 26. Liquid water obtained from water vapor in the exhaust gas discharged from the water electrolysis device 22 is supplied to the gas-liquid separator 26 that stores water to be supplied to the water electrolysis device 22, via the liquid water supply path 65. Therefore, the water used in the water electrolysis device 22 can be saved.

The oxygen supply mechanism 36 includes an oxygen exhaust gas flow path 66, the gas-liquid separator 68, and a circulation pump 70, in addition to the configuration of the supply mechanism 16 described above. The oxygen exhaust gas flow path 66 is a path for returning, back to the fuel cell 12, the oxygen-containing exhaust gas discharged from the fuel cell 12. The oxygen exhaust gas flow path 66 has an upstream partial flow path 66A and a downstream partial flow path 66B. The upstream partial flow path 66A connects the fuel cell 12 and the gas-liquid separator 68. The downstream partial flow path 66B connects a portion of the second supply path 40B between the flow regulating valve 60 and the fuel cell 12, to the gas-liquid separator 68.

The gas-liquid separator 68 and the circulation pump 70 are provided on the oxygen exhaust gas flow path 66. The gas-liquid separator 68 separates the oxygen-containing exhaust gas discharged from the fuel cell 12 to the oxygen exhaust gas flow path 66, into a gas component (oxygen gas and water vapor) and a liquid component (liquid water). The gas component is supplied back to the fuel cell 12 by the circulation pump 70. On the other hand, the liquid component is supplied to the water tank 30 via a water supply path 71. The water supply path 71 connects the gas-liquid separator 68 and the water tank 30.

The hydrogen supply mechanism 38 includes, in addition to the configuration of the supply mechanism 16 described above, a hydrogen exhaust gas flow path 72, a gas-liquid separator 74, and a circulation pump 76. The hydrogen exhaust gas flow path 72 is a path for returning, back to the fuel cell 12, the hydrogen-containing exhaust gas discharged from the fuel cell 12. The hydrogen exhaust gas flow path 72 has an upstream partial flow path 72A and a downstream partial flow path 72B. The upstream partial flow path 72A connects the fuel cell 12 and the gas-liquid separator 74. The downstream partial flow path 72B connects a portion of the second supply path 40B between the flow regulating valve 60 and the fuel cell 12, to the gas-liquid separator 74.

The gas-liquid separator 74 and the circulation pump 76 are provided on the hydrogen exhaust gas flow path 72. The gas-liquid separator 74 separates the hydrogen-containing exhaust gas discharged from the fuel cell 12 to the hydrogen exhaust gas flow path 72, into a gas component (hydrogen gas and water vapor) and a liquid component (liquid water). The gas component is supplied back to the fuel cell 12 by the circulation pump 76. On the other hand, the liquid component is supplied to the water tank 30 via a water supply path 77. The water supply path 77 connects the gas-liquid separator 74 and the water tank 30.

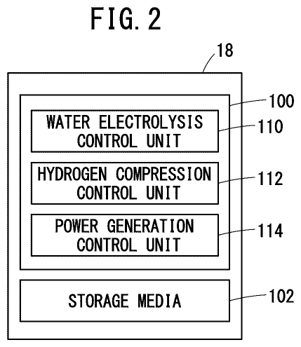

FIG. 2 is a block diagram of the control device 18. The control device 18 includes one or more processors 100 and one or more storage media 102. The storage medium 102 may be constituted by a volatile memory and a non-volatile memory. The processor 100 may be a CPU, a GPU, or the like. As examples of the volatile memory, there may be cited a RAM or the like. As examples of the non-volatile memory, there may be cited a ROM, a flash memory, or the like.

The processor 100 includes a water electrolysis control unit 110, a hydrogen compression control unit 112, and a power generation control unit 114. When the processor 100 executes a program stored in the storage medium 102, the processor 100 operates as the water electrolysis control unit 110, the hydrogen compression control unit 112, and the power generation control unit 114. At least one of the water electrolysis control unit 110, the hydrogen compression control unit 112, and the power generation control unit 114 may be realized by an integrated circuit such as an ASIC, an FPGA, or the like. At least one of the water electrolysis control unit 110, the hydrogen compression control unit 112, and the power generation control unit 114 may be configured by an electronic circuit including a discrete device.

The water electrolysis control unit 110 can execute operation control of the water electrolysis device 22 and operation stop control of the water electrolysis device 22. For example, when the processor 100 receives an operation start instruction of the regenerative fuel cell system 10, the water electrolysis control unit 110 starts operation control of the water electrolysis device 22.

In the operation control of the water electrolysis device 22, the water electrolysis control unit 110 drives the water supply pump 31 to supply water to the water electrolysis device 22. In the operation control of the water electrolysis device 22, the water electrolysis control unit 110 controls the power supply device 23 such that an electric current of a predetermined value flows between the cathode and the anode of the water electrolysis device 22.

When the operation control of the water electrolysis device 22 is executed, oxygen gas generated in the water electrolysis device 22 is supplied to the pressure container 42 of the oxygen supply mechanism 36 via the gas supply path 40 of the oxygen supply mechanism 36. On the other hand, the hydrogen gas generated in the water electrolysis device 22 is supplied to the hydrogen compression device 24 via the hydrogen supply path 32.

For example, when the amount of gas supplied to the pressure container 42 of the oxygen supply mechanism 36 exceeds a predetermined amount of gas, the water electrolysis control unit 110 shifts from the operation control of the water electrolysis device 22 to the operation stop control of the water electrolysis device 22. The operation stop control of the water electrolysis device 22 will be described later.

The hydrogen compression control unit 112 can execute operation control of the hydrogen compression device 24 and operation stop control of the hydrogen compression device 24. For example, when supply of hydrogen gas to the third partial flow path 32C of the hydrogen supply path 32 is confirmed, the hydrogen compression control unit 112 performs operation control of the hydrogen compression device 24. The supply of hydrogen gas to the third partial flow path 32C is confirmed based on, for example, a flow sensor or the like provided in the third partial flow path 32C near the hydrogen compression device 24.

In the operation control of the hydrogen compression device 24, the hydrogen compression control unit 112 drives the gas supply pump 34 to supply hydrogen gas to the hydrogen compression device 24. In the operation control of the hydrogen compression device 24, the hydrogen compression control unit 112 controls the power supply device 25 such that an electric current of a predetermined value flows between the cathode and the anode of the hydrogen compression device 24.

When the operation control of the hydrogen compression device 24 is executed, hydrogen gas generated in the hydrogen compression device 24 is supplied to the pressure container 42 of the hydrogen supply mechanism 38 via the gas supply path 40 of the hydrogen supply mechanism 38.

For example, when the supply of hydrogen gas to the third partial flow path 32C is not confirmed, the hydrogen compression control unit 112 shifts from the operation control of the hydrogen compression device 24 to the operation stop control of the hydrogen compression device 24. The operation stop control of the hydrogen compression device 24 will be described later.

The power generation control unit 114 can execute operation control of the fuel cell 12 and operation stop control of the fuel cell 12. For example, when the amount of electric power stored in the battery 20 falls below a lower limit value, the power generation control unit 114 starts the operation control of the fuel cell 12.

In the operation control of the fuel cell 12, the power generation control unit 114 opens the second on-off valve 48 of the oxygen supply mechanism 36 and drives the circulation pump 70 of the oxygen supply mechanism 36. The power generation control unit 114 opens the second on-off valve 48 of the hydrogen supply mechanism 38 and drives the circulation pump 76 of the hydrogen supply mechanism 38. The power generation control unit 114 controls at least one of the second pressure regulating valve 52 and the flow regulating valve 60 based on a target power generation amount and the like.

When the operation control of the fuel cell 12 is executed, the oxygen gas stored in the pressure container 42 of the oxygen supply mechanism 36 is supplied to the fuel cell 12 through the second supply path 40B of the oxygen supply mechanism 36. The oxygen gas that has not undergone the electrochemical reaction in the fuel cell 12 flows into the second supply path 40B of the oxygen supply mechanism 36 through the oxygen exhaust gas flow path 66, and is supplied to the fuel cell 12 again.

The hydrogen gas stored in the pressure container 42 of the hydrogen supply mechanism 38 is supplied to the fuel cell 12 through the second supply path 40B of the hydrogen supply mechanism 38. The hydrogen gas that has not undergone the electrochemical reaction in the fuel cell 12 flows into the second supply path 40B of the hydrogen supply mechanism 38 through the hydrogen exhaust gas flow path 72, and is supplied to the fuel cell 12 again.

For example, when the amount of electric power stored in the battery 20 exceeds an upper limit value, the power generation control unit 114 shifts from the operation control of the fuel cell 12 to the operation stop control of the fuel cell 12.

In the operation stop control of the fuel cell 12, the power generation control unit 114 closes the second on-off valve 48 of the oxygen supply mechanism 36 and stops the circulation pump 70 of the oxygen supply mechanism 36. The power generation control unit 114 closes the second on-off valve 48 of the hydrogen supply mechanism 38 and stops the circulation pump 76 of the hydrogen supply mechanism 38. The power generation control unit 114 stops the control of the second pressure regulating valve 52 and the flow regulating valve 60.

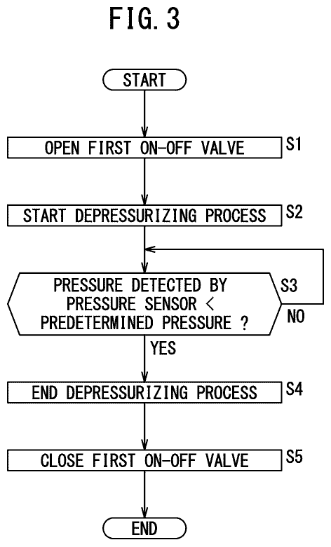

Next, the operation stop control of the gas generation device 14 will be described. The operation stop control of the water electrolysis device 22 and the operation stop control of the hydrogen compression device 24 are basically the same. Therefore, only the operation stop control of the water electrolysis device 22 will be described here unless otherwise specified. FIG. 3 is a flowchart showing a procedure of the operation stop control of the water electrolysis device 22.

In step S1, the water electrolysis control unit 110 opens the first on-off valve 46 of the oxygen supply mechanism 36. When the first on-off valve 46 is opened, the operation stop control of the water electrolysis device 22 is shifted to step S2.

In step S2, the water electrolysis control unit 110 starts a depressurizing process. In the depressurizing process, the water electrolysis control unit 110 controls the power supply device 23 such that the current flowing between the electrodes of each electrochemical cell of the water electrolysis device 22 gradually decreases.

In addition, in the depressurizing process, the water electrolysis control unit 110 adjusts the opening degree of the first pressure regulating valve 50 so as to achieve a target depressurization rate, based on the pressure detected by the pressure sensor 62. This can suppress a rapid decrease in gas pressure, and as a result, it is possible to suppress the occurrence of blisters and the like in the electrolyte membrane of the water electrolysis device 22.

The opening degree of the first pressure regulating valve 50 is adjusted, for example, as follows. That is, the water electrolysis control unit 110 measures a depressurization rate, which is the pressure reduction per unit time, based on the pressure detected by the pressure sensor 62, and calculates the difference between the depressurization rate and the target depressurization rate. The target depressurization rate is a target value of the depressurization rate for suppressing the occurrence of blisters and the like, and is stored in the storage medium 102. The water electrolysis control unit 110 sets the opening degree of the first pressure regulating valve 50 such that the difference from the target depressurization rate is reduced. The opening degree of the first pressure regulating valve 50 is set to be smaller as the difference from the target depressurization rate is larger.

In the depressurizing process of the operation stop control of the hydrogen compression device 24, the hydrogen compression control unit 112 adjusts the opening degree of the second pressure regulating valve 52. When the depressurizing process is started, the operation stop control of the water electrolysis device 22 proceeds to step S3.

In step S3, the water electrolysis control unit 110 compares the pressure detected by the pressure sensor 62 with a predetermined pressure. When the pressure detected by the pressure sensor 62 is equal to or higher than the predetermined pressure, the water electrolysis control unit 110 continues to compare the pressure detected by the pressure sensor 62 with the predetermined pressure. On the other hand, when the pressure detected by the pressure sensor 62 is less than the predetermined pressure, the operation stop control of the water electrolysis device 22 proceeds to step S4.

In step S4, the water electrolysis control unit 110 ends the depressurizing process. That is, the water electrolysis control unit 110 stops the control of the power supply device 23 and stops the electrochemical reaction (water electrolytic reactions) in the water electrolysis device 22. The water electrolysis control unit 110 sets the opening degree of the flow regulating valve 60 to a predetermined opening degree. When the depressurizing process is completed, the operation stop control of the water electrolysis device 22 proceeds to step S5.

In step S5, the water electrolysis control unit 110 closes the first on-off valve 46 of the oxygen supply mechanism 36 and stops the water supply pump 31. Thus, the operation stop control of the water electrolysis device 22 is ended.

As shown in FIG. 1, when the first on-off valve 46 is opened in the operation stop control, oxygen gas generated in the water electrolysis device 22 flows into the bypass path 44 from the branch portion BP of the gas supply path 40. The oxygen gas that has flowed into the bypass path 44 is supplied to the fuel cell 12. The oxygen gas generated in the water electrolysis device 22 contains water vapor obtained by vaporizing alkaline water which has been supplied to the water electrolysis device 22 and has moved from the cathode to the anode together with hydroxide ions, as described above. When the depressurizing process of the operation stop control is started, the differential pressure between the cathode and the anode decreases, and the amount of water pushed back from the anode to the cathode by the differential pressure decreases. Therefore, a larger amount of water vapor generated by alkaline water being vaporized occurs at the anode than during the operation control. That is, the present invention can be more effective for the operation stop control of differential pressure water electrolysis devices in which the amount of water vapor is not large during the operation control and a large amount of water vapor is generated during the operation stop control.

The regenerative fuel cell system 10 is provided with a gas flow path 200 for suppressing supply of alkaline water to the fuel cell 12. The gas flow path 200 includes a gas flow path 200A for guiding oxygen gas and a gas flow path 200B for guiding hydrogen gas.

The gas flow path 200A includes a first flow path portion (bypass path 44), a second flow path portion (downstream partial flow path 66B), and the inside of a storage container 202 provided in the gas-liquid separator 68.

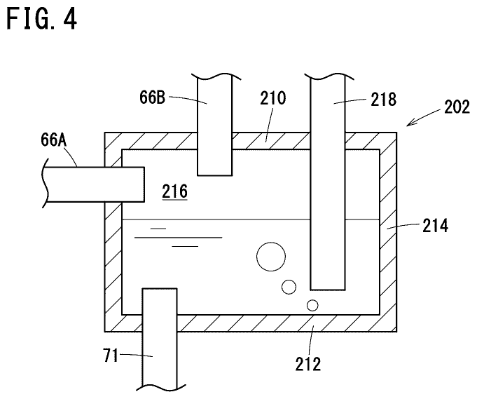

FIG. 4 is a view showing the storage container 202. The storage container 202 has an internal space 216 surrounded by an upper wall 210, a lower wall 212, and side walls 214. Generated water is stored in the internal space 216. The generated water is liquid water generated by power generation of the fuel cell 12 and separated by the gas-liquid separator 68. The liquid water generated by the power generation of the fuel cell 12 is acidic.

The water level of the generated water may be maintained within a predetermined range. For example, when the water level detected by a water level sensor provided in the storage container 202 falls below a lower limit water level, the power generation control unit 114 executes the operation control of the fuel cell 12. When the water level detected by the water level sensor reaches an upper limit water level, the power generation control unit 114 shifts from the operation control of the fuel cell 12 to the operation stop control of the fuel cell 12. A part of the generated water stored in the storage container 202 is supplied to the water tank 30 at an optional timing. In this case, the control device 18 opens an on-off valve (not shown) provided in the water supply path 71 to supply the generated water to the water tank 30.

The upstream partial flow path 66A of the oxygen exhaust gas flow path 66 penetrates the upper portion of one of the sidewalls 214. The downstream end of the upstream partial flow path 66A is located above the generated water that is stored in the internal space 216. As shown in FIG. 1, the upstream end of the upstream partial flow path 66A is connected to the fuel cell 12.

The downstream partial flow path 66B of the oxygen exhaust gas flow path 66 penetrates the upper wall 210. The upstream end of the downstream partial flow path 66B is located above the water surface of the generated water stored in the internal space 216. As shown in FIG. 1, the downstream end of the downstream partial flow path 66B is connected to the second supply path 40B.

The storage container 202 is provided with a tubular member 218. The tubular member 218 extends through the upper wall 210 and under the water surface of the generated water. The tubular member 218 may be the downstream end of the bypass path 44. Alternatively, the tubular member 218 may be a member separate from the bypass path 44. In this case, the upper end of the tubular member 218 and the downstream end of the bypass path 44 are joined to each other. The lower end of the tubular member 218 is positioned below the water surface of the generated water stored in the internal space 216. The lower end of the tubular member 218 is spaced apart from the lower wall 212.

The oxygen gas that has flowed into the bypass path 44 when the first on-off valve 46 is opened in the operation stop control reaches the tubular member 218. The oxygen gas that has reached the tubular member 218 is released into the generated water from the lower end of the tubular member 218. The oxygen gas released into the generated water becomes bubbles and moves upward and beyond the water surface of the generated water. In this case, the water (alkaline water vapor) containing oxygen gas is neutralized by the generated water. The oxygen gas that has moved upward and beyond the water surface of the generated water flows into the downstream partial flow path 66B of the oxygen exhaust gas flow path 66, and is supplied to the fuel cell 12 through the second supply path 40B.

In this way, the gas flow path 200 guides the oxygen gas generated at the anode of the water electrolysis device 22 to the fuel cell 12 through the generated water stored in the storage container 202. Thus, even if alkaline water is contained in the oxygen gas, the water can be neutralized by the generated water stored in the storage container 202. In particular, a more remarkable advantageous effect can be exhibited by supplying the gas in the operation stop control, which may generate the water vapor obtained by a larger amount of alkaline water being vaporized, to the storage container 202. Therefore, alkaline water does not reach the fuel cell 12, and it is possible to suppress deterioration of the seal member, the electrolyte membrane, and the like provided in the fuel cell 12 due to the alkaline water. As a result, it is possible to suppress a decrease in the durability of the fuel cell 12.

The gas flow path 200B is a hydrogen supply path 32 for guiding the hydrogen gas generated in the electrolytic device 22, to the hydrogen compression device 24 through the supplementary water stored in the water tank 30. The gas flow path 200B includes a first partial flow path 32A, a second partial flow path 32B, a part of the water tank 30, and a third partial flow path 32C.

Although not shown, the downstream end of the second partial flow path 32B of the hydrogen supply path 32 is provided in the water tank 30 as a member corresponding to the tubular member 218. The downstream end of the second partial flow path 32B penetrates the upper wall of the water tank 30 and extends under the water surface of the supplementary water stored in the water tank 30. The supplementary water is liquid water (generated water) stored in the storage container 202, and therefore is acidic.

As described above, the hydrogen gas separated by the gas-liquid separator 26 is the hydrogen gas generated by the water electrolysis device 22. Therefore, the hydrogen gas flowing from the gas-liquid separator 26 into the second partial flow path 32B contains water vapor obtained by alkaline water being vaporized. The hydrogen gas that has flowed into the second partial flow path 32B is discharged into the supplementary water from the lower end of the second partial flow path 32B. The hydrogen gas released into the supplementary water becomes bubbles and moves upward and beyond the water surface of the supplementary water. In this case, the water (alkaline water vapor) containing hydrogen gas is neutralized by the supplementary water. The hydrogen gas that has moved upward and beyond the water surface of the supplementary water flows into the third partial flow path 32C and is supplied to the hydrogen compression device 24.

In this way, the hydrogen supply path 32 guides the hydrogen gas generated by the water electrolysis device 22 to the hydrogen compression device 24 through the supplementary water stored in the water tank 30. Thus, even if alkaline water is contained in the hydrogen gas, the water can be neutralized by the supplementary water stored in the water tank 30. Therefore, alkaline water does not reach the fuel cell 12, and it is possible to suppress deterioration of the seal member, the electrolyte membrane, and the like provided in the fuel cell 12 due to the alkaline water. As a result, it is possible to suppress a decrease in the durability of the fuel cell 12.

### Second Embodiment

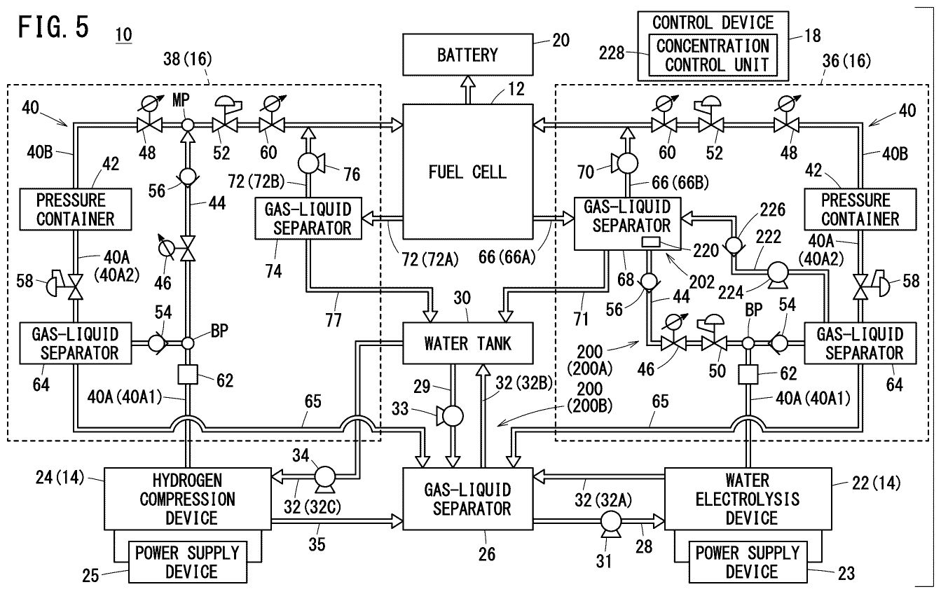

FIG. 5 is a schematic view showing the regenerative fuel cell system 10 according to a second embodiment. In FIG. 5, the same components as those described in the first embodiment are denoted by the same reference numerals. In the second embodiment, descriptions that overlap or are duplicative of those stated in the first embodiment are omitted.

In the second embodiment, a concentration measurement device 220, a water supply path 222, a water supply pump 224, a check valve 226, and a concentration control unit 228 are further provided.

The concentration measurement device 220 is provided in the storage container 202. The concentration measurement device 220 measures the hydrogen ion concentration of the generated water stored in the storage container 202. The concentration measurement device 220 may be a pH meter.

The water supply path 222 connects the gas-liquid separator 64 and the storage container 202. The water supply path 222 is provided with the water supply pump 224 and the check valve 226. The water supply pump 224 supplies the water stored in the gas-liquid separator 64 to the storage container 202. The water stored in the gas-liquid separator 64 is alkaline. The water supply pump 224 is driven by the concentration control unit 228.

The concentration control unit 228 operates when the processor 100 (FIG. 2) executes a program. The concentration control unit 228 may be realized by an integrated circuit such as an ASIC, an FPGA, or the like. The concentration control unit 228 may be configured by an electronic circuit including a discrete device. The concentration control unit 228 can execute concentration control for adjusting the concentration of the generated water stored in the storage container 202 based on the hydrogen ion concentration measured by the concentration measurement device 220.

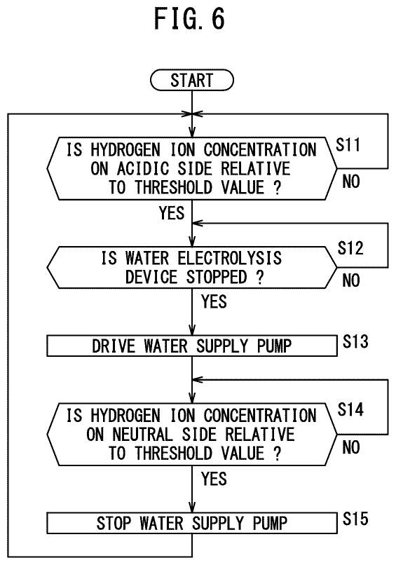

FIG. 6 is a flowchart showing a procedure of the concentration control. The concentration control is performed, for example, during the operation period of the regenerative fuel cell system 10.

In step S11, the concentration control unit 228 compares the hydrogen ion concentration measured by the concentration measurement device 220 with a threshold value. The threshold value is set to, for example, a hydrogen ion concentration corresponding to a hydrogen ion concentration index selected from the range of pH6 to pH7. When the hydrogen ion concentration measured by the concentration measurement device 220 is on the neutral side relative to the threshold value, the concentration control unit 228 continues to compare the hydrogen ion concentration measured by the concentration measurement device 220 with the threshold value. On the other hand, when the hydrogen ion concentration measured by the concentration measurement device 220 is on the acidic side relative to the threshold value, the concentration control proceeds to step S12.

In step S12, the concentration control unit 228 determines whether the water electrolysis device 22 is stopped. When the water electrolysis control unit 110 (FIG. 2) is executing the operation control or the operation stop control, the concentration control unit 228 determines that the water electrolysis device 22 is not stopped. In this case, the concentration control does not proceed to step S13. On the other hand, when the water electrolysis control unit 110 (FIG. 2) is executing neither the operation control nor the operation stop control, the concentration control unit 228 determines that the water electrolysis device 22 is stopped. In this case, the concentration control proceeds to step S13.

In step S13, the concentration control unit 228 drives the water supply pump 224. When the water supply pump 224 is driven, the concentration control shifts to step S14.

In step S14, the concentration control unit 228 compares the hydrogen ion concentration measured by the concentration measurement device 220 with the threshold value. When the hydrogen ion concentration measured by the concentration measurement device 220 is on the acidic side relative to the threshold value, the concentration control unit 228 continues to drive the water supply pump 224. On the other hand, when the hydrogen ion concentration measured by the concentration measurement device 220 is on the neutral side relative to the threshold value, the concentration control proceeds to step S15.

In step S15, the concentration control unit 228 stops the water supply pump 224. When the water supply pump 224 is stopped, the concentration control shifts to step S11.

The amount of water (acidic water) generated by the power generation of the fuel cell 12 and then supplied to the storage container 202 is larger than the amount of water (alkaline water) supplied to the storage container 202 during the operation stop control of the water electrolysis device 22. Therefore, the acidity of the generated water stored in the storage container 202 tends to become high (the acidity becomes stronger).

In the present embodiment, when the hydrogen ion concentration measured by the concentration measurement device 220 is on the acidic side relative to the threshold value, the concentration control unit 228 drives the water supply pump 224. Thus, the acidity of the generated water stored in the storage container 202 can be prevented from becoming high (becoming stronger).

In the present embodiment, the concentration control unit 228 drives the water supply pump 224 when the water electrolysis device 22 is stopped. This can prevent the alkalinity of the generated water stored in the storage container 202 from becoming high (strengthening).

The following Supplementary Notes are further disclosed in relation to the above embodiments.

### (Supplementary Note 1)

The regenerative fuel cell system (10) of the present disclosure includes the water electrolysis device (22) that performs electrolysis of alkaline water, the fuel cell (12) that performs power generation by using a generated gas that is a gas generated by the electrolysis, the storage container (202) that stores generated water that is water generated by the power generation, and the gas flow path (200) that guides the generated gas to the fuel cell through the generated water stored in the storage container.

### (Supplementary Note 2)

The regenerative fuel cell system according to Supplementary Note 1 may further include the pressure container (42) configured to store the generated gas of high pressure, and the pressure control valve (58) provided in the first supply path (40A) that is configured to guide the generated gas from the water electrolysis device to the pressure container, wherein the gas flow path may include the first flow path portion (44) that connects the first supply path and the storage container, and the second flow path portion (66B) that connects the storage container and the second supply path (40B) that is configured to guide the generated gas from the pressure container to the fuel cell.

### (Supplementary Note 3)

In the regenerative fuel cell system according to Supplementary Note 2, the first flow path portion may include the tubular member (218) that penetrates the upper wall (210) of the storage container and extends under a water surface of the generated water.

### (Supplementary Note 4)

The regenerative fuel cell system according to Supplementary Note 2 may further include the on-off valve (46) provided in the first flow path portion, and the water electrolysis control unit (110) configured to control the water electrolysis device. The water electrolysis control unit may close the on-off valve during operation control of the water electrolysis device, and open the on-off valve when operation stop control of the water electrolysis device is started.

### (Supplementary Note 5)

The regenerative fuel cell system according to Supplementary Note 1 may further include the concentration measurement device (220) configured to measure the hydrogen ion concentration of the generated water stored in the storage container, the water supply pump (224) configured to supply the alkaline water to the storage container, and the concentration control unit (228) that adjusts the hydrogen ion concentration of the generated water. When the hydrogen ion concentration measured by the concentration measurement device is on the acidic side relative to the threshold value, the concentration control unit may drive the water supply pump.

### (Supplementary Note 6)

In the regenerative fuel cell system according to Supplementary Note 5, the concentration control unit may drive the water supply pump when the water electrolysis device is stopped.

### (Supplementary Note 7)

The regenerative fuel cell system according to Supplementary Note 1 may further include the water tank (30) configured to store supplementary water that is water to be added to the alkaline water, the hydrogen compression device (24) configured to pressurize hydrogen gas, and the hydrogen supply path (32) configured to guide the hydrogen gas generated by the water electrolysis device to the hydrogen compression device through the supplementary water stored in the water tank. The gas flow path may guide oxygen gas generated in the water electrolysis device to the fuel cell through the generated water.

Although the present disclosure has been described in detail, the present disclosure is not limited to the above-described embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. These embodiments may also be implemented in combination. For example, in the above- described embodiments, the order of operations and the order of processes are shown as examples, and the present invention is not limited to them. The same applies to a case where numerical values or mathematical equations are used in the description of the above-described embodiments.

1. A regenerative fuel cell system comprising:
a water electrolysis device configured to perform electrolysis of alkaline water;
a fuel cell configured to perform power generation by using a generated gas that is a gas generated by the electrolysis;
a storage container configured to store generated water that is water generated by the power generation; and
a gas flow path configured to guide the generated gas to the fuel cell through the generated water stored in the storage container.

2. The regenerative fuel cell system according to claim 1, further comprising:
a pressure container configured to store the generated gas of high pressure; and
a pressure control valve provided in a first supply path that is configured to guide the generated gas from the water electrolysis device to the pressure container,
wherein
the gas flow path includes:
a first flow path portion that connects the first supply path and the storage container; and
a second flow path portion that connects the storage container and a second supply path that is configured to guide the generated gas from the pressure container to the fuel cell.

3. The regenerative fuel cell system according to claim 2, wherein
the first flow path portion includes a tubular member that penetrates an upper wall of the storage container and extends under a water surface of the generated water.

4. The regenerative fuel cell system according to claim 2, further comprising:
an on-off valve provided in the first flow path portion; and
a control device comprising one or more processors that execute computer-executable instructions stored in a memory,
wherein
the one or more processors execute the computer-executable instructions to cause the control device to close the on-off valve during operation control of the water electrolysis device, and open the on-off valve when operation stop control of the water electrolysis device is started.

5. The regenerative fuel cell system according to claim 1, further comprising:
a concentration measurement device configured to measure a hydrogen ion concentration of the generated water stored in the storage container;
a water supply pump configured to supply the alkaline water to the storage container; and
a control device comprising one or more processors that execute computer-executable instructions stored in a memory,
wherein
when the hydrogen ion concentration measured by the concentration measurement device is on an acidic side relative to a threshold value, the one or more processors execute the computer-executable instructions to cause the control device to drive the water supply pump.

6. The regenerative fuel cell system according to claim 5, wherein
the one or more processors cause the control device to drive the water supply pump when the water electrolysis device is stopped.

7. The regenerative fuel cell system according to claim 1, further comprising:
a water tank configured to store supplementary water that is water to be added to the alkaline water;
a hydrogen compression device configured to pressurize hydrogen gas; and
a hydrogen supply path configured to guide the hydrogen gas generated by the water electrolysis device to the hydrogen compression device through the supplementary water stored in the water tank,
wherein
the gas flow path guides oxygen gas generated in the water electrolysis device to the fuel cell through the generated water.
